(19) United States
(12) Patent Application Publication
(10) Pub. No.: US 2012/0322697 A1
(43) Pub. Date: Dec. 20, 2012

(54) COMPOSITIONS AND METHODS FOR ENHANCING FLUID RECOVERY FOR HYDRAULIC FRACTURING TREATMENTS

(75) Inventor: Kewei Zhang, Calgary (CA)

(73) Assignee: TRICAN WELL SERVICE LTD, Calgary, AB (CA)

(21) Appl. No.: 13/522,679

(22) PCT Filed: Jan. 21, 2011
(86) PCT No.: PCT/CA2011/000065

§ 371 Date: Jul. 17, 2012

(30) Foreign Application Priority Data
Jan. 21, 2010 (CA) 2690768

(51) Int. Cl. C09K 8/62

(52) U.S. Cl. 507/205; 507/219; 507/234

(57) ABSTRACT

A method of altering the wettability of a subterranean formation comprising the steps of providing a fluid with a FEA; introducing the fluid into a subterranean formation whereby the wettability of the formation is altered, wherein the FEA is selected from a group consisting of organosiloxane, organosilane, fluoro-organosiloxane, fluoro-organosilane, and fluorocarbon compounds.

### FIELD

This invention relates to hydraulic fracturing in general and fluid flowback compositions for hydraulic fracturing in particular.

### BACKGROUND

Hydraulic fracturing operations are used routinely to increase oil and gas production. In a hydraulic fracturing process, a fracturing fluid is injected through a wellbore into a subterranean formation at a pressure sufficient to initiate a fracture to increase oil and gas production. Frequently, particulates, called proppants, are suspended in the fracturing fluid and transported into the fracture as slurry. Proppants include sand, resin coated proppant, ceramic particles, glass spheres, bauxite (aluminum oxide), and the like. Among them, sand is by far the most commonly used proppant. Fracturing fluids in common use include various aqueous and hydrocarbon fluids. Liquid carbon dioxide and nitrogen gas are occasionally used in fracturing treatments. The most commonly used fracturing fluids are aqueous fluids containing polymers, either linear or cross-linked, to initiate fractures in the formation and effectively transport proppants into the fractures.

In the past few years, water or water containing a small amount of friction reducer, has been widely used in tight formations including shale formations. Aqueous fluids gelled by viscoelastic surfactants are also commonly used. At the last stage of a fracturing treatment, fracturing fluid is flowed back to surface and proppants are left in the fracture to prevent it from closing back after pressure is released. The proppant-filled fracture provides a high conductive channel that allows oil and/ or gas to seep through to the wellbore more efficiently. The conductivity of the proppant pack plays an important role in increasing oil and gas production.

After a treatment, a large portion of the fluid is trapped in the formation and which cannot be flowed back to the surface. It is known that the success of a fracturing treatment is closely related to the amount of the fracturing fluid recovered after the treatment. Normally, the more fracturing fluid that is recovered, the higher the production of the well after the treatment.

Recovery of the fluid depends on several factors and among them capillary pressure is one of the most important. The capillary pressure Δρ is governed by a simple, albeit somewhat approximate, relation as shown in the following equation:

$$Δ p = \frac{2 σ}{r} cos θ \qquad ( I )$$

where σ represents the surface tension of fluid, r the radius of pore and θ the contact angle. For a certain formation, pore size, i.e., r is constant, and therefore there are only two parameters, namely σ and θ, are left to be adjusted in order to manipulate the capillary pressure.

Currently, the most common method is to add surfactants to the fracturing fluid to reduce the surface tension σ, and thus the capillary pressure Δρ, and consequently, the resistence to flowback. The limitation of the approach is that it is very hard to reduce the surface tension of an aqueous fluid to be under 30 dyne/cm.

### SUMMARY

In one aspect, the invention relates to a method of altering the wettability of a subterranean formation comprising the steps of providing a fluid with a FEA; introducing the fluid into a subterranean formation whereby the wettability of the formation is altered, wherein the the FEA is selected from a group consisting of organosiloxane, organosilane, fluoro-organosiloxane, fluoro-organosilane, and fluorocarbon compounds. The fluid contains a sufficient amount of an FEA to alter the wettability of the formation when the fluid contacts the formation. The wettability of the formation can be altered by changing the contact angle of the formation. The contact angle of the formation can be altered to be about or greater than 90°. The wettability of the formation can be altered such that a fluid contacting the formation is repelled by the formation. The fluid can be a fracturing fluid. The fluid can be a pad fluid which does not contain a proppant. The FEA can be a suitable organosilicon compound. The organosilicon compound can be selected from the group consisting of organosiloxane, organosilane, fluoro-organosiloxane and fluoro-organosilane compounds. Fluids according to the present invention can further comprise nanoparticles.

### DESCRIPTION

In one or more embodiments, this invention relates to compositions and methods for enhancing fluid recovery by manipulating the capillary, force through changing the contact angle. It is found that when a flowback enhancing agent “(FEA)”, that can make the contact angle approximately equal or larger than 90°, is added to a fracturing fluid, the fluid recovery can be enhanced significantly.

Referring to equation (I), one can also manipulate the capillary pressure by changing the contact angle θ, .i.e., the wettability. By changing the contact angle, the capillary pressure can be greatly changed. For example, when the contact angle becomes 90°, cos θ becomes zero, so does the capillary pressure, or when the contact angle is larger than 90°, cos θ becomes negative meaning the fluid, such as an aqueous fracturing fluid, is repelled by the pores in a subterranean formation.

In one or more embodiments of this invention, a sufficient amount of a FEA is added to a fluid and the fluid is then injected into a subterranean formation. The fluid can be a fracture pad fluid which is an initial part of a fracture fluid that creates a fracture but contains no proppant. Such a fracturing pad fluid when introduced into a subterranean formation can alter the wettability of pores in the formation by changing the contact angle θ. A fracture fluid with proppant can then be introduced into the formation. The fracture fluid can optionally contain a FEA.

There are various types of FEA that can be used in fluids of the present invention, including many organosilicon compounds, for example, organosilicon compounds selected from the group consisting of organosiloxane, organosilane, fluoro-organosiloxane and fluoro-organosilane compounds. See also U.S. Pat. Nos. 4,537,595; 5,240,760; 5,798,144; 6,323,268; 6,403,163; 6,524,597 and 6,830,811 which are incorporated herein by reference, and which disclose organosilicon compounds. The selection of organosilicon compounds suitable for the present invention from the aforementioned references can be made by one of ordinary skilled in the art through routine testing.

Organosilanes are compounds containing silicon to carbon bonds. Organosiloxanes are compounds containing Si—O—Si bonds. Polysiloxanes are compounds in which the elements silicon and oxygen alternate in the molecular skeleton, i.e., Si—O—Si bonds are repeated. The simplest polysiloxanes are polydimethylsiloxanes.

Polysiloxane compounds can be modified by various organic substitutes having different numbers of carbons, which may contain N, S, or P moieties that impart desired characteristics. For example, cationic polysiloxanes are compounds in which one or more organic cationic groups are attached to the polysiloxane chain, either at the middle or the end. The organic cationic group may also contain a hydroxyl group or other functional groups containing N or O. The most common organic cationic groups are alkyl amine derivatives including primary, secondary, tertiary and quaternary amines (for example, quaternary polysiloxanes including, quaternary polysiloxanes including mono- as well as, di-quaternary polysiloxanes, amido quaternary polysiloxanes, imidazoline quaternary polysiloxanes and carboxy quaternary polysiloxanes.

Similarly, the polysiloxane can be modified by organic amphoteric groups, where one or more organic amphoteric groups are attached to the polysiloxane chain, either at the middle or the end, and include betaine polysiloxanes and phosphobetaine polysiloxanes.

Similarly, the polysiloxane can be modified by organic anionic groups, where one or more organic anionic groups are attached to the polysiloxane chain, either at the middle or the end, including sulfate polysiloxanes, phosphate polysiloxanes, carboxylate polysiloxanes, sulfonate polysiloxanes, thiosulfate polysiloxanes. The organosiloxane compounds also include alkylsiloxanes including hexamethylcyclotrisiloxane, octamethylcyclotetrasiloxane, decamethylcyclopentasiloxane, hexamethyldisiloxane, hexaethyldisiloxane, 1,3-divinyl-1,1,3,3-tetramethyldisiloxane, octamethyltrisiloxane, decamethyltetrasiloxane.

The organosilane compounds include alkylchlorosilane, for example methyltrichlorosilane, dimethyldichlorosilane, trimethylchlorosilane, octadecyltrichlorosilane; alkyl- alkoxysilane compounds, for example methyl-, propyl-, isobutyl- and octyltrialkoxysilanes, cationic silanes including amine silanes.

Other types of chemical compounds, which are not organosilicon compounds, which can be used are certain fluoro-substituted compounds, for example certain fluorocarbon compounds including amphoteric and cationic fluoro-organic compounds. These compounds have been widely used to make solid surface not only hydrophobic but also oleophobic.

Further information regarding organosilicon compounds can be found in Silicone Surfactants (Randal M. Hill, 1999) and the references therein, and in U.S. Pat. Nos. 4,046,795; 4,537,595; 4,564,456; 4,689,085; 4,960,845; 5,098,979; 5,149,765; 5,209,775; 5,240,760; 5,256,805; 5,359,104; 6,132,638 and 6,830,811 and Canadian Patent No. 2,213,168 which are incorporated herein by reference, and which disclose organosilicon compounds. The selection of organosilicon compounds suitable for the present invention from the aforementioned references can be made by one of ordinary skilled in the art through routine testing.

Organosilanes can be represented by the formula

RₙSiX₍₄₋ₙ₎ (II)

wherein R is an organic radical having 1-50 carbon atoms that may posses functionality containing N, S, or P moieties that imparts desired characteristics, X is a halogen, alkoxy, acyloxy or amine and n has a value of 0-3. Examples of organosilanes include:

CH₃SiCl₃, CH₃CH₂SiCl₃, (CH₃)₂SiCl₂, (CH₃CH₂)₂SiCl₂, (C₆H₅)₂SiCl₂, (C₆H₅)SiCl₃, (CH₃)₃SiCl, CH₃HSiCl₂, (CH₃)₂HSiCl, CH₃SiBr₃, (C₆H₅)SiBr₃, (CH₃)₂SiBr₂, (CH₃CH₂)₂SiBr₂, (C₆H₅)₂SiBr₂, (CH₃)₃SiBr, CH₃HSiBr₂, (CH₃)₂HSiBr, Si(OCH₃)₄, CH₃Si(OCH₃)₃, CH₃Si(OCH₂CH₃)₃, CH₃Si(OCH₂CH₂CH₃)₃, CH₃Si[O(CH₂)₃CH₃]₃, CH₃CH₂Si(OCH₂CH₃)₃, C₆H₅Si(OCH₃)₃, C₆H₅CH₂Si(OCH₃)₃, C₆H₅Si(OCH₂CH₃)₃, CH₂═CHCH₂Si(OCH₃)₃, (CH₃)₂Si(OCH₃)₂, (CH₂=CH)Si(CH₃)₂Cl, (CH₃)₂Si(OCH₂CH₃)₂, (CH₃)₂Si(OCH₂CH₂CH₃)₂, (CH₃)₂Si[O(CH₂)₃CH₃]₂, (CH₃CH₂)₂Si(OCH₂CH₃)₂, (C₆H₅)₂Si(OCH₃)₂, (C₆H₅CH₂)₂Si(OCH₃)₂, (C₆H₅)₂Si(OCH₂CH₃)₂, (CH₂═CH₂)Si(OCH₃)₂, (CH₂═CHCH₂)₂Si(OCH₃)₂, (CH₃)₃SiOCH₃, CH₃HSi(OCH₃)₂, (CH₃)₂HSi(OCH₃), CH₃Si(OCH₂CH₂CH₃)₃, CH₂═CHCH₂Si(OCH₂CH₂OCH₃)₂, (C₆H₅)₂Si(OCH₂CH₂OCH₃)₂, (CH₃)₂Si(OCH₂CH₂OCH₃)₂, (CH₂═CH₂)₂Si(OCH₂CH₂OCH₃)₂, (CH₂═CHCH₂)₂Si(OCH₂CH₂OCH₃)₂, (C₆H₅)₂Si(OCH₂CH₂OCH₃)₂, CH₃Si(CH₃COO)₃, 3-aminotriethoxysilane, methyldiethylchlorosilane, butyltrichlorosilane, diphenyldichlorosilane, vinyltrichlorosilane, methyltrimethoxysilane, vinyltriethoxysilane, vinyltris(methoxyethoxy)silane, methacryloxypropyltrimethoxysilane, glycidoxypropyltrimethoxysilane, aminopropyltriethoxysilane, divinyldi-2-methoxysilane, ethyltributoxysilane, isobutyltrimethoxysilane, hexyltrimethoxysilane, n-octyltriethoxysilane, dihexyldimethoxysilane, octadecyltrichlorosilane, octadecyltrimethoxysilane, octadecyldimethylchlorosilane, octadecyldimethylmethoxysilane and quaternary ammonium silanes including 3-(trimethoxysilyl)propyldimethyloctadecyl ammonium chloride, 3-(trimethoxysilyl)propyldimethyloctadecyl ammonium bromide, 3-(trimethylethoxysilylpropyl)didecylmethyl ammonium chloride, triethoxysilyl soyapropyl dimonium chloride, 3-(trimethylethoxysilylpropyl)didecylmethyl ammonium bromide, 3-(trimethylethoxysilylpropyl)didecylmethyl ammonium bromide, triethoxysilyl soyapropyl dimonium bromide, (CH₃O)₃Si(CH₂)₃P⁺(C₆H₅)₃Cl, (CH₃O)₃Si(CH₂)₃P+(C₆H₅)₃Br—, (CH₃O)₃Si(CH₂)₃P⁺(CH₃)₃Cl—, (CH₃O)₃Si(CH₂)₃P⁺(C₆H₁₃)₃Cl—, (CH₃O)₃Si(CH₂)₃N⁺(CH₃)₂C₄H₉Cl, (CH₃O)₃Si(CH₂)₃N⁺(CH₃)₂CH₂C₆H₅Cl—, (CH₃O)₃Si(CH₂)₃N⁺(CH₃)₂CH₂CH₂OHCl⁻, (CH₃O)₃Si(CH₂)₃N⁺(C₂H₅)₃Cl⁺, (C₂H₅O)₃Si(CH₂)₃N⁺(CH₃)₂C₁₈H₃₇Cl—.

Among different organosiloxane compounds which are useful for the present invention, polysiloxanes modified with organic amphoteric or cationic groups including organic betaine polysiloxanes and organic amine polysiloxanes where the amine group can be primary, secondary, tertiary and quaternary amines. One type of betaine polysiloxane or quaternary polysiloxane is represented by the formula

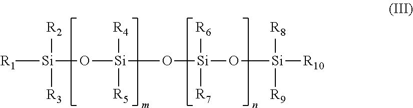

wherein each of the groups R₁ to R₆, and R₈ to R₁₀ represents an alkyl containing 1-6 carbon atoms, typically a methyl group, R₇ represents an organic betaine group for betaine polysiloxane, or an organic quaternary group for quaternary polysiloxane, and have different numbers of carbon atoms, and may contain a hydroxyl group or other functional groups containing N, P or S, and m and n are from 1 to 200. For example, one type of quaternary polysiloxanes is when R₇ is represented by the group

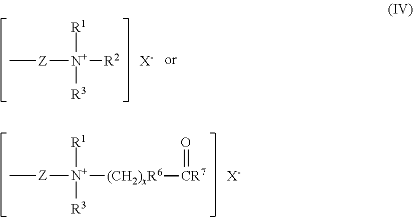

wherein R¹, R², R³ are alkyl groups with 1 to 22 carbon atoms or alkenyl groups with 2 to 22 carbon atoms. R⁴, R⁵, R⁷ are alkyl groups with 1 to 22 carbon atoms or alkenyl groups with 2 to 22 carbon atoms; R⁶ is -0- or the NR⁸ group, R⁸ being an alkyl or hydroxyalkyl group with 1 to 4 carbon atoms or a hydrogen group; Z is a bivalent hydrocarbon group with at least 4 carbon atoms, which may have a hydroxyl group and may be interrupted by an oxygen atom, an amino group or an amide group; x is 2 to 4; The R¹, R², R³, R⁴, R⁵, R⁷ may be the same or the different, and X— is an inorganic or organic anion including Cl— and CH₃COO—. Examples of organic quaternary groups include [R—N⁺(CH₃)₂—CH₂CH(OH)CH₂—O—(CH₂)₃—](CH₃COO—), wherein R is an alkyl group containing from 1-22 carbons or an benzyl radical and CH₃COO— an anion. Examples of organic betaine include -(CH₂)₃—O—CH₂CH(OH)(CH₂)—N⁺(CH₃)₂CH₂CO—. Such compounds are commercial available. It should be understood that cationic polysiloxanes include compounds represented by formula (III), wherein R₇ represents other cationic groups including organic amine derivatives including organic primary, secondary and tertiary amines. Other examples of organo-modified polysiloxanes include di-betaine polysiloxanes and di-quaternary polysiloxanes, which can be represented by the formula

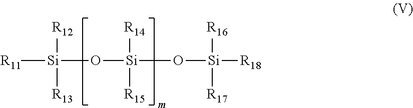

wherein the groups R₁₂ to R₁₇ each represents an alkyl containing 1-6 carbon atoms, typically a methyl group, both R₁₁ and R₁₈ group represent an organic betaine group for di-betaine polysiloxanes or an organic quaternary group for di-quaternary, and have different numbers of carbon atoms and may contain a hydroxyl group or other functional groups containing N, P or S, and m is from 1 to 200. For example, one type of di-quaternary polysiloxanes is when R₁₁ and R₁₈ are represented by the group

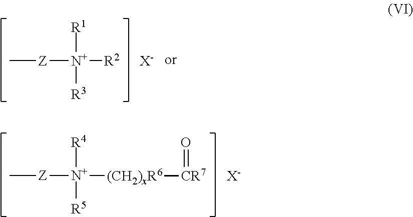

wherein R¹, R², R³, R⁴, R⁵, R⁶, R⁷, Z, X— and x are the same as defined above. Such compounds are commercially available.

It will be appreciated by those skilled in the art that cationic polysiloxanes include compounds represented by formula (V), wherein R₁₁ and R₁₈ represents other cationic groups including organic amine derivatives including organic primary, secondary and tertiary amines. It will be apparent to those skilled in the art that there are different mono- and di-quaternary polysiloxanes, mono- and di-betaine polysiloxanes and other organo-modified polysiloxane compounds which can be used in the present invention. These compounds are widely used in personal care and other products, for example as discussed in U.S. Pat. Nos. 4,054,161; 4,654,161; 4,891,166; 4,898,957; 4,933,327; 5, 166, 297; 5,235,082; 5,306,434; 5,474,835; 5,616,758; 5,798,144; 6,277,361; 6,482,969; 6,323,268 and 6,696,052 which are incorporated herein by reference. The selection from these references of compounds suitable for the present invention can be made by one of ordinary skill in the art through routine testing.

Another example of organosilicon compounds which can be used in the composition of the present invention are fluoro-organosilane or fluro-organosiloxane compounds in which at least part of the organic radicals in the silane or siloxane compounds are fluorinated. Suitable examples are fluorinated chlorosilanes or fluorinated alkoxysilanes including 2-(n-perfluoro-octyl)ethyltriethoxysilane, perfluoro-octyldimethylchlorosilane, (CF₃CH₂CH₂)₂Si(OCH₃)₂, CF₃CH₂CH₂Si(OCH₃)₃, (CF₃CH₂CH₂)₂Si(OCH₂CH₂OCH₃)₂ and CF₃CH₂CH₂Si(OCH₂CH₂OCH₃)₃ and (CH₃O)₃Si(CH₂)₃N⁺(CH₃)₂(CH₂)₃NHC(O)(CF₂)₆CF₃Cl—, and tridecafluorooctyltriethoxysilane Also, compounds in which fluorocarbon groups are attached to poly(dimethylsiloxane) (PDMS) backbone including poly(methylnonafluorohexylsiloxane) can also be used. Other compounds which can be used, are fluoro-substituted compounds, which contain no silicon group, for example, certain fluorocarbon compounds, in which at least part of the organic radicals are fluoronated. Among them, fluorocarbon compounds containing amphoteric or cationic groups including various amine derivatives including cationic fluoro-polymers are preferred. Some examples of cationic fluoro-polymers can be found in U.S. Pat. No. 5,798,415. It is known that fluorocarbon compounds, and especially fluoro-organosilane or fluro-organosiloxane compounds not only significantly increase the contact angle of an aqueous liquid but also of oils, to about or greater than 90°. In other words, compounds according to the present invention can make a subterranean formation or pore surfaces not only hydrophobic but also oleophobic (oil repellent). Oleophobicity facilitates production from subterranean formations such as oil wells and also can aid in well flow back when hydrocarbon fracturing fluids are used.

Optionally, nanoparticles, for example SiO₂ nanoparticles, can be added into a fluid comprising an FEA of the present invention. Nanoparticles are normally considered to be particles having one or more dimensions of the order of 100 nm or less. The surface property of a nanoparticle can be either hydrophilic or hydrophobic. Adsorption of the nanoparticles on the fracture surface or proppant surface may further enhance hydrophobicity and oleophobicity. Nanoparticles of different types and sizes are commercial available and have been used to treat solid surface, in combination with hydrophobizing agents, to make highly hydrophobic or oleophobic surfaces for various applications.

There are various methods for implementing the present invention. Normally, an FEA of the present invention can be first mixed with a solvent and then added to a fracturing fluid, preferably to a pad fluid which does not contain proppant. Alternatively, the FEA can be added to the fluid during the whole well stimulation operation. Alternatively the FEA can be used together with other surfactants. Common fracturing fluids known to the industry can be used. Among them, aqueous-based fluids including water, slick water and gelled water, and hydrocarbon-based fluids including gelled hydrocarbons are preferred.

### EXAMPLE 1

Two aqueous fluids, Fluid-I and Fluid-II, were prepared. Fluid-I contains 2.0 L/m³ CC-77 in water, while Fluid-II contains 0.01 L/ m³ of Tegopren 6924 and 2.0 L/ m³ CC-77 in water. Tegopren 6924 is a di-quaternary polydimethylsiloxane from BASF Corp and CC-7 is a clay stabilizer. Standard Berea sandstone core (150-200 mD) was used. The core was saturated initially with brine and the initial permeability was measured with N2. The core was then treated with the fluid and the final permeability was measured with N2. The confining pressure was 1,500 psi and the temperature was 50° C. The regain permeability for Fluid-I was 33.1% while for Fluid-II was 95.2%.

### EXAMPLE 2

Two aqueous fluids, Fluid-I and Fluid-II, were prepared. Fluid-I contained 2.0 L/m³ CC-77 in water, while Fluid-II contained 0.01 L/m³ of an amino-polysiloxane and 2.0 L/m³ CC-77 in water. Standard Berea sandstone core (1-5 mD) was used. The core was saturated initially with brine and the initial permeability was measured with N2. The core then was treated with the fluid and the final permeability was measured with N2. The confining pressure was 2,500 psi and the temperature was 50° C. The regain permeability for Fluid-I was 78.9% while for Fluid-II was 95.8%.

### EXAMPLE 3

2 ml of a solution containing 20% Tegopren 6924 and 80% of ethylene glycol mono-butyl ether, 2 ml of TEGO Betaine 810 and 2 ml of CC-7 were added into 1000 ml of water containing 250 grams of 40/70 mesh fracturing sand. TEGO Betaine 810 is capryl/capramidopropyl betaine. After thoroughly mixing, the solution, designated as Fluid-II, was separated from sands and used to measure the regain permeability. For comparison, regain permeability of a solution, designated as Fluid-I, containing 2 ml/L of CC-7 and 2 ml/L of S-2 was also tested. S-2 is a non-ionic surfactant that is commonly used for enhancing fluid recovery. Standard Berea sandstone core and 5 pore volume were used. The maximum regain permeability for Fluid-II was 78.7% while for Fluid-I was 112.1%.

1. A method of altering the wettability of a subterranean formation comprising the steps of:
providing a fluid with a FEA;
introducing the fluid into a subterranean formation whereby the wettability of the formation is altered, wherein the the FEA is selected from a group consisting of organosiloxane, organosilane, fluoro-organosiloxane, fluoro-organosilane, and fluorocarbon compounds.

2. The method of claim 1 wherein the fluid contains a sufficient amount of an FEA to alter the wettability of the formation when the fluid contacts the formation.

3. The method of claim 2 wherein the wettability of the formation is altered by changing the contact angle of the formation.

4. The method of claim 3 wherein the contact angle of the formation is altered to be about 90°.

5. The method of claim 3 wherein the contact angle of the formation is altered to be greater than 90°.

6. The method of claim 2 wherein wettability of the formation is altered such that a fluid contacting the formation is repelled by the formation.

7. The method of claim 1 wherein the fluid is a fracturing pad fluid.

8. The method of claim 1 wherein the fluid does not contain a proppant.

9. The method of claim 7 wherein the fluid is an aqueous-based pad fluid.

10. The method of claim 7 wherein the fluid is a hydrocarbon-based pad fluid.

11. The method of claim 1 wherein the FEA is a suitable organosilicon compound.

12. The method of claim 11 wherein the organosilicon compound is selected from the group consisting of organosiloxane, organosilane, fluoro-organosiloxane and fluoro-organosilane compounds.

13. The method of claim 9 further comprising nanoparticles.

14. The method of claim 1, wherein the FEA is an organosilane having the formula
RₙSiX₍₄₋ₙ₎
wherein R is an organic radical having 1-50 carbon atoms that may posses a functionality containing N, S, or P moieties that imparts desired characteristics, X is a halogen, alkoxy, acyloxy or amine and n has a value of 0-3.

15. The method of claim 1, wherein the FEA is selected from a group consisting of:
CH₃SiCl₃, CH₃CH₂SiCl₃, (CH₃)₂SiCl₂, (CH₃CH₂)₂SiCl₂, (C₆H₅)₂SiCl₂, (C₆H₅)SiCl₃, (CH₃)₃SiCl, CH₃HSiCl₂, (CH₃)₂HSiCl, CH₃SiBr₃, (C₆H₅)SiBr₃, (CH₃)₂SiBr₂, (CH₃CH₂)₂SiBr₂, (C₆H₅)₂SiBr₂, (CH₃)₃SiBr, CH₃HSiBr₂, (CH₃)₂HSiBr, Si(OCH₃)₄, CH₃Si(OCH₃)₃, CH₃Si(OCH₂CH₃)₃, CH₃Si(OCH₂CH₂CH₃)₃, CH₃Si[O(CH₂)₃CH₃]₃, CH₃CH₂Si(OCH₂CH₃)₃, C₆H₅Si(OCH₃)₃, C₆H₅CH₂Si(OCH₃)₃, C₆H₅Si(OCH₂CH₃)₃, CH₂═CHCH₂Si(OCH₃)₃, (CH₃)₂Si(OCH₃)₂, (CH₂═CH)Si(CH₃)₂Cl, (CH₃)₂Si(OCH₂CH₃)₂, (CH₃)₂Si(OCH₂CH₂CH₃)₂, (CH₃)₂Si[O(CH₂)₃CH₃]₂, (CH₃CH₂)₂Si(OCH₂CH₃)₂, (C₆H₅)₂Si(OCH₃)₂, (C₆H₅CH₂)₂Si(OCH₃)₂, (C₆H₅)₂Si(OCH₂CH₃)₂, (CH₂═CH₂)Si(OCH₃)₂, (CH₂═CHCH₂)₂Si(OCH₃)₂, (CH₃)₃SiOCH₃, CH₃HSi(OCH₃)₂, (CH₃)₂HSi(OCH₃), CH₃Si(OCH₂CH₂CH₃)₃, CH₂═CHCH₂Si(OCH₂CH₂OCH₃)₂, (C₆H₅)₂Si(OCH₂CH₂OCH₃)₂, (CH₃)₂Si(OCH₂CH₂OCH₃)₂, (CH₂═CH₂)₂Si(OCH₂CH₂OCH₃)₂, (CH₂═CHCH₂)₂Si(OCH₂CH₂OCH₃)₂, (C₆H₅)₂Si(OCH₂CH₂OCH₃)₂, CH₃Si(CH₃COO)₃, 3-aminotriethoxysilane, methyldiethylchlorosilane, butyltrichlorosilane, diphenyldichlorosilane, vinyltrichlorosilane, methyltrimethoxysilane, vinyltriethoxysilane, vinyltris(methoxyethoxy)silane, methacryloxypropyltrimethoxysilane, glycidoxypropyltrimethoxysilane, aminopropyltriethoxysilane, ethyltributoxysilane, isobutyltrimethoxysilane, /hexyltrimethoxysilane, n-octyltriethoxysilane, dihexyldimethoxysilane, octadecyltrichlorosilane, octadecyltrimethoxysilane, octadecyldimethylchlorosilane, octadecyldimethylmethoxysilane and quaternary ammonium silanes including 3-(trimethoxysilyl)propyldimethyloctadecyl ammonium chloride, 3-(trimethoxysilyl)propyldimethyloctadecyl ammonium bromide, 3-(trimethylethoxysilylpropyl)didecylmethyl ammonium chloride, triethoxysilyl soyapropyl dimonium chloride, 3-(trimethylethoxysilylpropyl)didecylmethyl ammonium bromide, 3-(trimethylethoxysilylpropyl)didecylmethyl ammonium bromide, triethoxysilyl soyapropyl dimonium bromide, (CH₃O)₃Si(CH₂)₃P⁺(C₆H₅)₃Cl, (CH₃O)₃Si(CH₂)₃P⁺(C₆H₅)₃Br—, (CH₃O)₃Si(CH₂)₃P⁺(CH₃)₃Cl—, (CH₃O )₃Si(CH₂)₃P⁺(C₆H₁₃)₃Cl—, (CH₃O)₃Si(CH₂)₃N⁺(CH₃)₂C₄H₉Cl, (CH₃O)₃Si(CH₂)₃N⁺(CH₃)₂CH₂C₆H₅Cl—, (CH₃O)₃Si(CH₂)₃N⁺(CH₃)₂CH₂CH₂OHCl—, (CH₃O)₃Si(CH₂)₃N⁺(C₂H₅)₃Cl—, (C₂H₅O)₃Si(CH₂)₃N⁺(CH₃)₂C₁₈H₃₇Cl—.

16. The method of claim 1, wherein the FEA is an organosiloxane.

17. The method of claim 1, wherein the FEA is selected from a group consisting of polyalkylsiloxanes, cationic polysiloxane, amphoteric polysiloxanes, sulfate polysiloxanes, phosphate polysiloxanes, carboxylate polysiloxanes, sulfonate polysiloxanes, and thiosulfate polysiloxanes.

18. The composition of claim 1, wherein the FEA is selected from a group consisting of hexamethylcyclotrisiloxane, octamethylcyclotetrasiloxane, decamethylcyclopentasiloxane, hexamethyldisiloxane, hexaethyldisiloxane, 1,3-diinyl-1,1,3,3-tetramethyldisiloxane, octamethyltrisiloxane, decamethyltetrasiloxane.

19. The composition of claim 1, wherein the FEA is a polyalkylsiloxane.

20. The composition of claim 1, wherein the FEA is a cationic polysiloxane.

21. The composition of claim 1, wherein the FEA is a quaternary polysiloxane.

22. The composition of claim 1, wherein the FEA is an amophoteric polysiloxane.

23. The composition of claim 1, wherein the organosiloxane is a betaine polysiloxane.

24. The composition of claim 1, wherein the FEA is a fluorocarbon compound.

25. The composition of claim 1, wherein the FEA is a fluoro-organosilane.

26. The composition of claim 1, wherein the FEA is a fluoro-organosiloxane.

27. The composition of claim 1 wherein the organosiloxane is selected from a group consisting of sulfate polysiloxane, sulfonate polysiloxane, phosphate polysiloxane, carboxylate polysiloxane and thiosulfate polysiloxane.

28. The composition of claim 1, wherein the FEA is an organo-siloxane having the formula 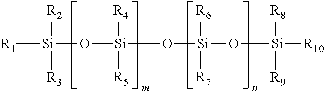
wherein each of R₁ to R6 and R₈ to Rio represents an organic radical containing 1-6 carbon atoms, typically a methyl group, R₇ represents an organic amphoteric group and m and n are from 1 to 200.

29. The composition of claim 1, wherein the FEA is an organo-siloxane having the formula 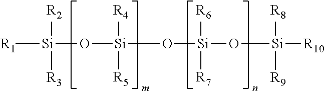
wherein each of Ri to R₆ and R₈ to Rio represents an organic radical containing 1-6 carbon atoms, typically a methyl group, R₇ represents an organic cationic group and m and n are from 1 to 200.

30. The composition of claim 1, wherein the FEA is a cationic polysiloxane having the formula 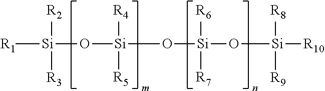
wherein each of R₁ to R₆ and R₈ to Rio, represents alkyl containing 1-6 carbon atoms, typically a methyl group, R₇ represents a quaternary group and is associated with an anionic ion and may have a hydroxyl group and may be interrupted by an oxygen atom, an amino group or an amide group, and m and n are from 1 to 200.

31. The composition of claim 1, wherein the FEA is a betaine polysiloxane having the formula 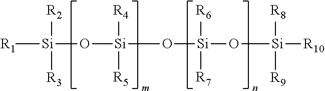
wherein each of R₁ to R₆ and R₈ to R₁₀, represents alkyl containing 1-6 carbon atoms, typically a methyl group, R₇ represents an organic betaine group and may have a hydroxyl group and may be interrupted by an oxygen atom, an amino group or an amide group, and m and n are from 1 to 200.

32. The composition of claim 1, wherein the FEA is an organo-siloxane having the formula 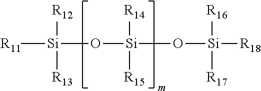
where R₁₂ to R₁₇ each represents an organic radical containing 1-6 carbon atoms, typically a methyl group, one of R₁₁ and R₁₈ represents an organic amphoteric group and the other of Rn and R18 represents an organic amphoteric group or an organic radical and m is from 1 to 200.

33. The composition of claim 1, wherein the FEA is an organo-siloxane having the formula 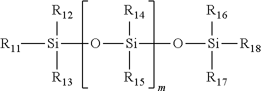
where R₁₂ to R₁₇ each represents an organic radical containing 1-6 carbon atoms, typically a methyl group, one of R₁₁ and R₁₈ represents an organic cationic group and the other of R₁₁ and R₁₈ represents an organic cationic group or an organic radical and m is from 1 to 200.

34. The composition of claim 1, wherein the FEA is according to the formula 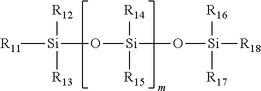
where R₁₂ to R₁₇ each represents alkyl containing 1-6 carbon atoms, typically a methyl group, R₁₁ and R₁₈ each represents an organic betaine group and may have a hydroxyl group and may be interrupted by an oxygen atom, an amino group or an amide group and m is 1 to 200.

35. The composition of claim 1, wherein the organosiloxane is according to the formula 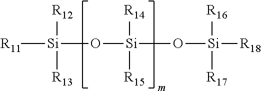
where R₁₂ to R₁₇ each represents alkyl containing 1-6 carbon atoms, typically a methyl group, R₁₁ and R₁₈ each independently represents an organic quaternary group and is associated with an anionic ion and may have a hydroxyl group and may be interrupted by an oxygen atom, an amino group or an amide group and m is 1 to 200.
